(19) United States
(12) Patent Application Publication
(10) Pub. No.: US 2016/0333864 A1
(43) Pub. Date: Nov. 17, 2016

(54) POWER AMPLIFICATION AND PRODUCTION DEVICE

(71) Applicants: Jerry Lee Hendricks, Dolan Springs, AZ (US); Robert Patrick Miles, Dolan Springs, AZ (US)

(72) Inventors: Jerry Lee Hendricks, Dolan Springs, AZ (US); Robert Patrick Miles, Dolan Springs, AZ (US)

(21) Appl. No.: 14/709,251

(22) Filed: May 11, 2015

(51) Int. Cl. F03G 3/00

(52) U.S. Cl. CPC F03G 3/00

(57) ABSTRACT

Some embodiments of the present disclosure include a device for amplifying energy. The device may include a frame and a pivoting power generator supported by the frame. The power generator may include an upper control arm and an attached lower control arm, a left axel shaft and a right axel shaft situated between the upper control arm and the lower control arm at opposite ends thereof, a center axel shaft configured to rotate upon the application of a first level of energy, and a spin arm attached to each of the left axel shaft and the right axel shaft, the spin arms configured to spin when the center axel rotates. In embodiments, a second level of energy greater in magnitude than the first level of energy may be collected from the spin arms.

### BACKGROUND

The embodiments herein relate generally to energy and power, and more particularly, to a device for amplifying and/or producing power.

Power is expensive to produce, and many conventional processes and devices for creating power or energy cause pollution. With pollution increasing worldwide, there is a movement toward trying to eliminate the production of pollution while simultaneously creating or providing the resources, such as power and energy, that the world requires.

Therefore, what is needed is a device configured to amplify or product power without creating pollution as a byproduct.

### SUMMARY

Some embodiments of the present disclosure include a device for amplifying energy. The device may include a frame and a pivoting power generator supported by the frame. The power generator may include an upper control arm and an attached lower control arm, a left axel shaft and a right axel shaft situated between the upper control arm and the lower control arm at opposite ends thereof, a center axel shaft configured to rotate upon the application of a first level of energy, and a spin arm attached to each of the left axel shaft and the right axel shaft, the spin arms configured to spin when the center axel rotates. In embodiments, a second level of energy greater in magnitude than the first level of energy may be collected from the spin arms.

### BRIEF DESCRIPTION OF THE FIGURES

The detailed description of some embodiments of the invention is made below with reference to the accompanying figures, wherein like numerals represent corresponding parts of the figures.

FIG. 1 is a perspective view of one embodiment of the present invention.

FIG. 2 is a perspective view of one embodiment of the present invention.

FIG. 3 is a top view of one embodiment of the present invention.

FIG. 4 is a top view of one embodiment of the present invention.

### DETAILED DESCRIPTION OF CERTAIN EMBODIMENTS

In the following detailed description of the invention, numerous details, examples, and embodiments of the invention are described. However, it will be clear and apparent to one skilled in the art that the invention is not limited to the embodiments set forth and that the invention can be adapted for any of several applications.

The device of the present disclosure may be used to amplify and produce power and may comprise the following elements. This list of possible constituent elements is intended to be exemplary only, and it is not intended that this list be used to limit the device of the present application to just these elements. Persons having ordinary skill in the art relevant to the present disclosure may understand there to be equivalent elements that may be substituted within the present disclosure without changing the essential function or operation of the device.
1. Frame
2. Power Control Arms
3. Spin Arms
4. Axel Shafts
5. Sprockets
6. Chains

The various elements of the device for amplifying and producing power of the present disclosure may be related in the following exemplary fashion. It is not intended to limit the scope or nature of the relationships between the various elements and the following examples are presented as illustrative examples only.

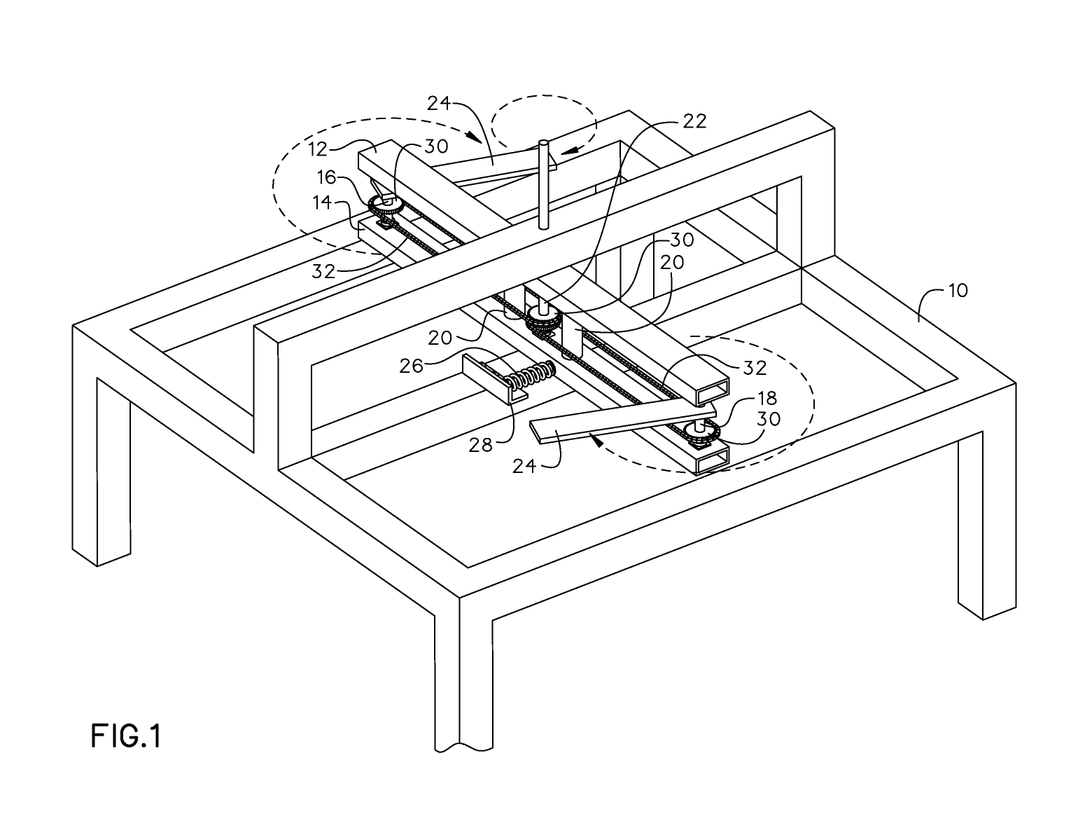

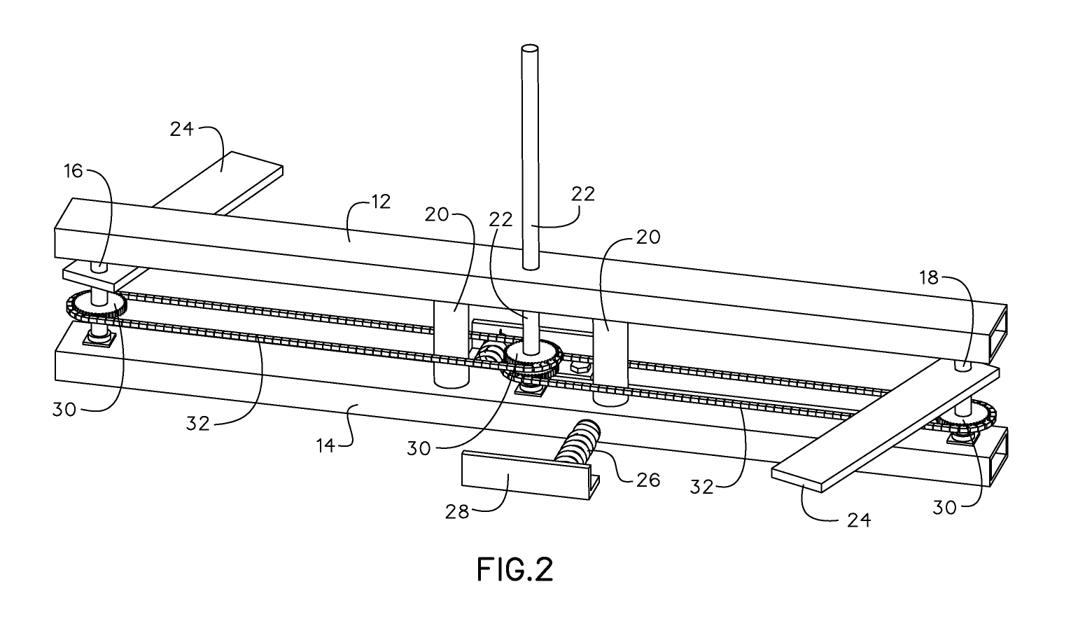

By way of example, and referring to FIGS. 1-4, some embodiments of the power production device of the present disclosure comprise a frame 10 configured to support a pivoting power generator, the power generator comprising an upper control arm 12 and a lower control arm 14 connected to the upper control arm 12 by a plurality of control arm pillars 20, such that the upper control arm 12 and the lower control arm 14 are parallel to one another, a left axel shaft 16 situated between the upper control arm 12 and the lower control arm 14 at a first end thereof, a right axel shaft 18 situated between the upper control arm 12 and the lower control arm 14 at a second end thereof, and a center axel shaft 22 situated at a central region of the upper control arm 12 and the lower control arm 14, the center axel shaft extending through the upper control arm 12 and through an upper portion of the frame 10, wherein the center axel shaft is configured to rotate within an orifice in the frame 10. Each of the left axel shaft 16, the right axel shaft 18, and the center axel shaft 20 may have a chain 32 rotatably attached thereto, wherein a first chain 32 is attached to the left axel shaft 16 and the center axel shaft 20, and a second chain 32 is attached to the right axel shaft 18 and the center axel shaft 20, such that when the center axel shaft 20 spins, the left axel shaft 16 and the right axel shaft 18 also spin. In some embodiments, each of the axel shafts 16, 18, 20 may comprise a sprocket 30 to which the chain 32 is attached. The left axel shaft 16 and the right axel shaft 18 my further comprise a spin arm 24 attached thereto, such that when the axel shafts 16, 18 rotate, the spin arms 24 spin between the control arms 12, 14, as shown in FIGS. 1, 3, and 4.

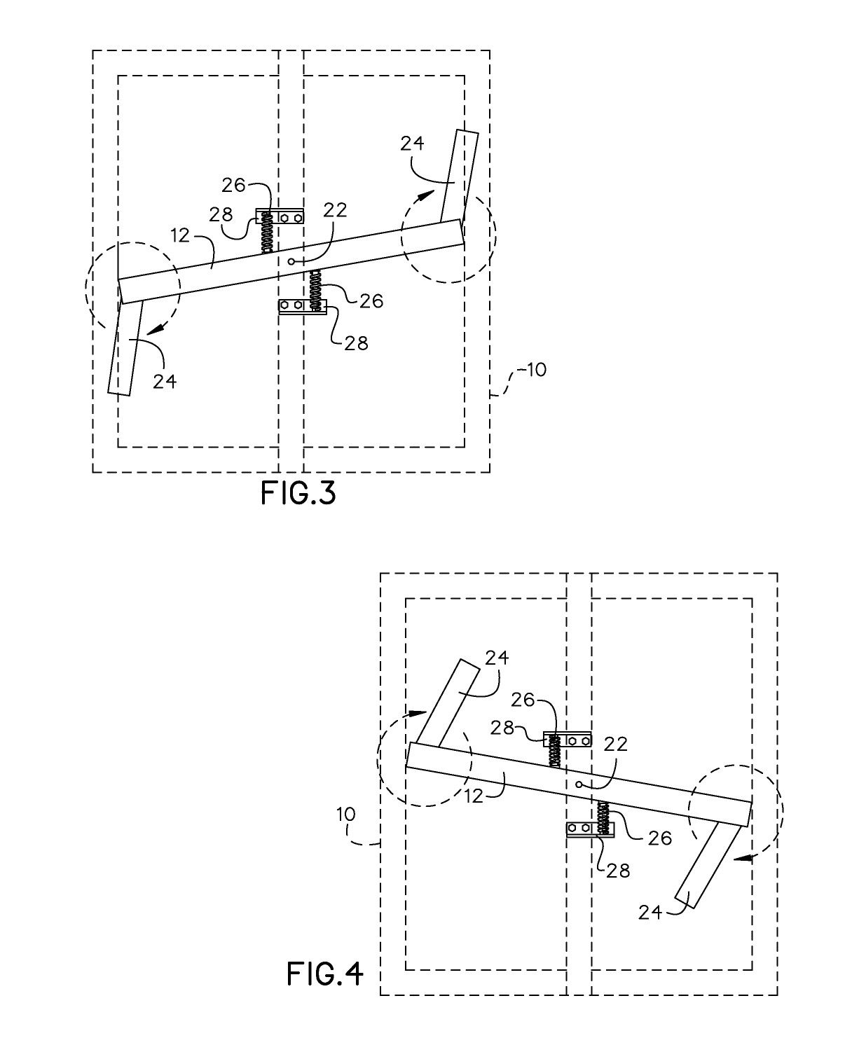

As shown in FIGS. 3 and 4, the frame 10 may comprise a rectangle or square outer edge with a bisecting beam running through the center of the frame 10, wherein the center axel shaft 22 concentrically aligns with the bisecting beam. A pair of spring brackets 28 may be attached to the bisecting beam on either side of the pivoting device, wherein a spring 26 connects each spring bracket 28 to the lower power control arm 14.

To use the device of the present invention, a user may temporarily attach a motor to the center axel shaft 22, causing it to rotate, which in turn causes the chains 32 to rotate the sprockets 30 on each of the left axel shaft 16 and the right axel shaft 18, causing the spin arms 24 to rotate, amplifying the energy from a level required to spin the center axel shaft 22 to a greater level, wherein the amplified energy may be collected from the spin arms 24. In some embodiments, the energy may be amplified at least about 10 times.

The device of the present disclosure may be made of any suitable materials and, in some embodiments, comprises a wood, metal, or plastic material.

Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

What is claimed is:

1. A device for amplifying energy, the device comprising:
a frame; and
a pivoting power generator supported by the frame, the power generator comprising:
an upper control arm;
a lower control arm connected to the upper control arm, such that the upper control arm and the lower control arm are parallel to one another with a space therebetween;
a left axel shaft situated between the upper control arm and the lower control arm at a first end thereof;
a right axel shaft situated between the upper control arm and the lower control arm at a second end thereof;
a center axel shaft situated at a central region of the upper control arm and the lower control arm, the center axel shaft being configured to rotate upon the application of a first level of energy;
a spin arm attached to each of the left axel shaft and the right axel shaft, the spin arms configured to spin when the center axel rotates,
wherein:
a second level of energy greater in magnitude than the first level of energy is configured to be collected from the spin arms.

2. The device of claim 1, wherein the upper control arm is connected to the lower control arm by a plurality of control arm pillars.

3. The device of claim 1, further comprising a motor removably attached to the center axel shaft, wherein:
the center axel shaft extends through the upper control arm and through an upper portion of the frame, the center axel shaft being configured to be rotated within an orifice in the frame; and
the motor is configured to be attached to the center axel shaft to begin rotating the center axel shaft and unattached once the center axel shaft is rotating.

4. The device of claim 1, wherein:
the center axel shaft is attached to the left axel shaft by a first chain; and
the center axel shaft is attached to the right axel shaft by a second chain, such that when the center axel shaft rotates, the left axel shaft and the right axel shaft also rotate.

5. The device of claim 4, wherein each of the axel shafts comprises a sprocket to which the respective chain is attached, the sprocket being attached to the axel shafts.

6. The device of claim 1, wherein the frame comprises a rectangular outer edge with a bisecting beam running through a center of the frame.

7. The device of claim 6, wherein the center axel shaft concentrically aligns with the bisecting beam.

8. The device of claim 6, wherein:
a pair of spring brackets is attached to the bisecting beam on either side of the pivoting power generator; and
a spring connects each spring bracket to the lower power control arm.

9. The device of claim 1, wherein the second energy level is at least about 10 times greater than the first energy level.
